(19) United States
(12) Patent Application Publication
(10) Pub. No.: US 2025/0004761 A1
(43) Pub. Date: Jan. 2, 2025

(54) METHOD AND SYSTEM FOR ACCESSING REGISTERS OF A DEVICE

(71) Applicant: MONTAGE TECHNOLOGY CO., LTD., Shanghai (CN)

(72) Inventors: Liangliang Niu, Shanghai (CN); Qiang Li, Shanghai (CN)

(73) Assignee: MONTAGE TECHNOLOGY CO., LTD., Shanghai (CN)

(21) Appl. No.: 18/752,030

(22) Filed: Jun. 24, 2024

(30) Foreign Application Priority Data
Jun. 28, 2023 (CN) 202310781080.8

(51) Int. Cl. G06F 9/30

(52) U.S. Cl. CPC G06F 9/30003; G06F 9/30098

(57) ABSTRACT

In a method and a system for accessing registers of a device, the device is connected to a CPU via a bus and includes multiple registers, each corresponding to a different address. Each register includes one or more storage units which share a register address. The access method includes: creating an instruction set for accessing the device; in response to operation requests from the CPU to the device, selecting corresponding instructions from the instruction set, to generate execution units with the minimum execution granularity corresponding to the operation requests; detecting the execution units, and when detecting that there are multiple execution units corresponding to the same type of operation request and multiple execution units includes multiple instructions of the same type corresponding to the same register address, merging and optimizing the multiple execution units to generate optimized execution units, and sending the optimized execution units to the bus.

### CROSS-REFERENCE TO PRIOR APPLICATION

This application claims priority to Chinese Application No. 202310781080.8 filed on Jun. 28, 2023, which is incorporated herein by reference in its entirety.

### TECHNICAL FIELD

This application relates to the field of computer technology, particularly to a method and a system for accessing registers of a device.

### BACKGROUND

Registers are core components of a central processing unit (CPU), which are high-speed storage components used to temporarily store instructions, data, and addresses. When executing instructions, the CPU can store data corresponding to the instructions into the registers. The existence of the registers greatly speeds up the efficiency of computing and memory access.

In computing systems, there may be some slow buses such as I2C/SMBus to manage devices. Users can operate these devices by programming or configuring the registers of these devices on these buses. From the perspective of specific device functions, the configuration of the registers often follows relatively fixed patterns: for example, when enabling a certain function of a device, a fixed group of registers are needed to be configured in a fixed order; when disabling a certain function of a device, a fixed group of registers are also needed to be configured in a fixed order. The registers can be roughly divided into two types. One is a register that includes only one storage unit, which exclusively occupies the address of the register, and the other is a register whose register space is divided into multiple storage units, which share the address of the register. In scenarios where batch operations are performed on certain functions of the device, the registers that include multiple storage units may be frequently configured.

Due to the use of slow buses, the overall performance of the system will be greatly affected when accessing devices on these buses (hereinafter referred to low-speed devices). When performing batch operations of certain functions, some registers that are divided into multiple storage units are frequently accessed, which further affects the performance of the system.

This section aims to provide background or context for the implementation of the application stated in the claims. The description here should not be considered prior art merely because it is included in this section.

### SUMMARY OF THE INVENTION

An object of this application is to provide a method and a system for accessing registers of a device, in order to reduce the number of accesses to these low-speed devices and improve system performance.

In one aspect, the present application provides a method for accessing registers of a device,
wherein the device is connected to a CPU via a bus, the device comprises multiple registers, each of which corresponds to a different address, and each register comprises one or more storage units which share a register address, and the access method comprises:
creating an instruction set for accessing the device;
in response to operation requests from the CPU to the device, selecting corresponding instructions from the instruction set, so as to generate execution units with the minimum execution granularity corresponding to the operation requests;
detecting the execution units, and when detecting that there are multiple execution units corresponding to the same type of operation request and the multiple execution units comprises multiple instructions of the same type corresponding to the same register address, merging and optimizing these multiple execution units to generate optimized execution units, and sending the optimized execution units to the bus.

In some embodiments, the method further comprises: detecting whether the register address corresponding to these multiple instructions of the same type is marked as an optimizable address, and merging and optimizing these multiple execution units when determining that the register address is the optimizable address.

In some embodiments, merging and optimizing these multiple execution units comprises: merging these multiple instructions of the same type corresponding to the same register address of the multiple execution units and generating an optimized instruction.

In some embodiments, merging and optimizing these multiple execution units comprises: sorting instructions that do not participate in merging and optimizing and the optimized instruction, so that relative order between any two instructions in the optimized execution units is the same as their relative order in the execution units before optimization.

In some embodiments, each of the instructions in the instruction set comprises an operation field, an address field, and a data field.

In some embodiments, operation fields and address fields of these multiple instructions of the same type are the same, and data fields of these multiple instructions of the same type correspond to different storage units of the register.

In some embodiments, merging multiple instructions of the same type corresponding to the same register address comprises: performing calculation on data in the data fields of these multiple instructions of the same type corresponding to the same register address based on the operation fields of these multiple instructions of the same type to obtain data in the data field of the optimized instruction, the operation field and the address field of the optimized instruction are respectively the same as those in the operation fields and the address fields of these multiple instructions of the same type.

In some embodiments, these multiple instructions of the same type are bit operation instructions of the same type.

In some embodiments, the instruction set is created in a domain specific language manner.

In another aspect, the present application provides an system for accessing registers of a device, wherein the device is connected to a CPU via a bus, the device comprises multiple registers, each of which corresponds to a different address, and each register comprises one or more storage units which share a register address, the access system comprises:
an instruction creating module, configured to create an instruction set for accessing the device;
an execution unit generator module, configured to select corresponding instructions from the instruction set in response to operation requests from the CPU to the device, so as to generate execution units with the minimum execution granularity corresponding to the operation requests;
an interpreter module, configured to detect the execution units, and when multiple execution units corresponding to the same type of operation request and including multiple instructions of the same type corresponding to the same register address are detected, merge and optimize the multiple execution units to generate optimized execution units, and send the optimized execution units to the bus.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a schematic diagram of registers in a device according to an embodiment of the present application.

FIG. 2 is a flowchart of a method for accessing registers of a device according to an embodiment of the present application.

FIG. 3 is a schematic diagram of configuration operations on registers in a device according to an embodiment of the present application.

FIG. 4 is a schematic diagram of multi-group configuration operations on registers in a device according to an embodiment of the present application.

FIG. 5 is a schematic diagram of multiple execution units before and after merging according to an embodiment of the present application.

FIG. 6 is a schematic diagram of a system for accessing registers of a device according to an embodiment of the present application.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

In order to make the objects, technical solutions and advantages of the present application more clearer, embodiments of the present application will be further described in detail below with reference to the accompanying drawings.

The present application relates to an access method for registers in a device, wherein the device is connected to a CPU via a bus, and the device includes multiple registers, each of which corresponds to a different address. It should be noted that the device described in this article refer to a low-speed device based on slow protocols (such as I2C, SPI, etc.). From the perspective of register organization, the registers included in the low-speed device can be divided into two types of registers. One includes only one storage unit, which exclusively occupies a single address, and this type of register is also called a register occupying an independent addressing unit; and the other includes multiple storage units, which share a single address, and each register unit occupies only one or several bits of the register, and this type of register is also called a register sharing an addressing unit. As shown in FIG. 1, assuming a low-speed device includes registers A, B, C, D, and E, the addresses corresponding to these registers are 0xA, 0xB, 0xC, 0xD, and 0xE, respectively. Among them, the registers A, B, C, and D each only includes one storage unit, which exclusively occupies the address of the register. That is to say, the registers A, B, C, and D all belong to registers that occupy independent addressing units. The register E includes six storage units, E0, E1, E2, E3, E4, and E5, which share the register address of register E. It should be understood that FIG. 1 is only for illustrative purpose, and in practice, the number of registers included in each slow-speed device, the number of storage units included in each register, etc. can be set as desired.

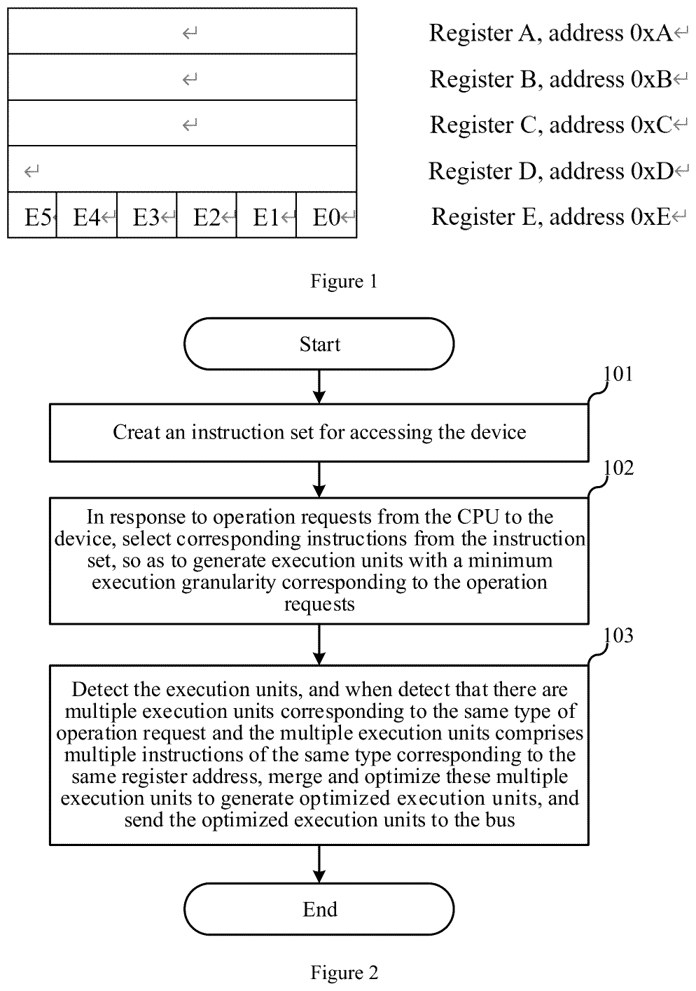

In the implementation of this application, the flowchart of the method for accessing registers of a device is shown in FIG. 2, the method includes:

Step 101, creating an instruction set for accessing the device.

In one embodiment, the instruction set is created in a domain specific language (DSL) manner, which is a defined instruction set used to access the registers in the device. The instruction set may include but is not limited to the following instructions: write instructions, read instructions, bit operation instructions (such as, OR instruction, AND instruction), null operation instructions, etc. Table 1 provides examples of some instructions and briefly describes their meanings.

TABLE 1
Examples of some instructions in the DSL instruction set

| Instruction | Meaning |
|---|---|
| REG_WRITE reg_x, data | Write a value data into the register reg_x |
| REG_READ mem, reg_x | Read a value from the |
| | register reg_x into a memory |
| | address specified by mem in memory |
| REG_OR reg_x, data | Read a value from the |
| | register reg_x, perform an OR |
| | operation with a value data, |
| | and then write the result |
| | of the OR operation into the register reg_x |
| REG_AND reg_x, data | Read a value from |
| | the register reg_x, perform an |
| | AND operation with a value data, |
| | and then write the |
| | result of the AND |
| | operation into the register reg_x |
| NOP | Null operation |

It can be seen that most instructions include an operation field, an address field, and a data field. Taking the instruction “REG_WRITE reg_x, data” as an example, “REG_WRITE” is the operation field used to indicate an operation type (that is, write operation), “reg_x” is the address field used to indicate an operation address, and “data” is the data field used to indicate an object being operated on.

Step 102, in response to operation requests from the CPU to the device, selecting instructions that implement the operation requests from the instruction set, so as to generate execution units with a minimum execution granularity corresponding to the operation requests.

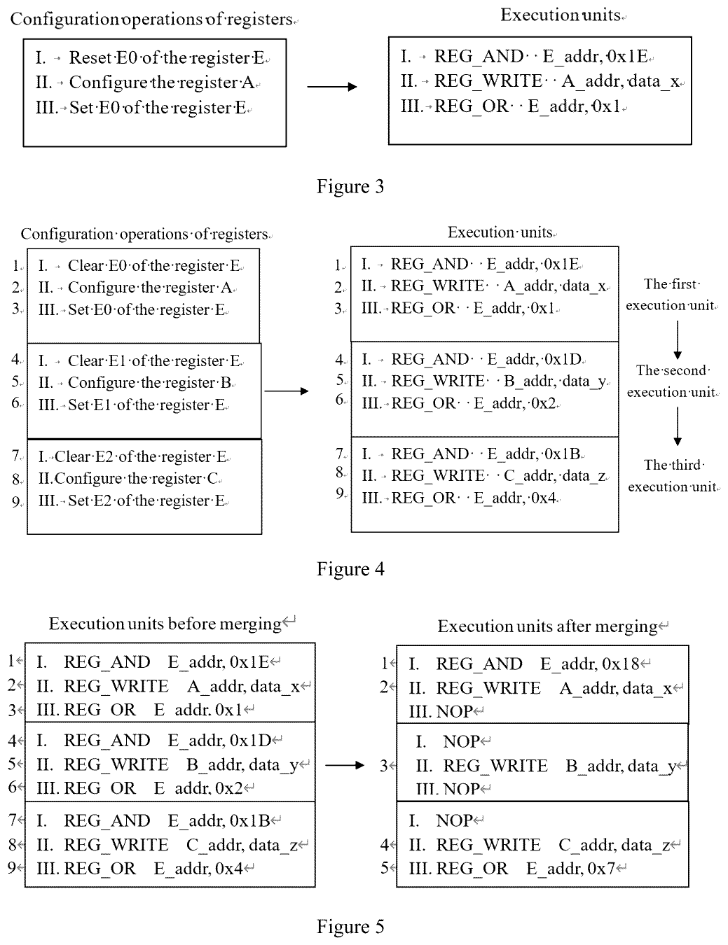

Referring to FIGS. 1 and 3, for example, to enable a certain function of the low-speed device, it is necessary to perform configuration operations shown in FIG. 3 on the registers in FIG. 1. This group of operations is necessary to enable the function, and can be referred to as the minimum execution granularity that enables the function. The above is only an example to illustrate the minimum execution granularity for the operation request, and enabling or disabling different functions has different configuration operations.

When receiving an operation request from the CPU to a low-speed device (such as enabling a certain function of the low-speed device), the corresponding instructions can be selected from a created instruction set to form the execution unit with the minimum execution granularity corresponding to the operation request. Continuing to refer to FIGS. 1 and 3, for example, each storage unit (E0, E1, E2 . . . ) in the register E may be a 1-bit storage unit, and an operation of clearing the register (or storage unit) is to set a value of the register (or storage unit) to 0, and an operation of setting the register (or storage unit) is to set a value of the register (or storage unit) to 1. After describing each operation in the minimum execution granularity using the instructions in the instruction set, a group of instructions as shown in FIG. 3 can be obtained, which constitutes an execution unit.

From this, it can be seen that the embodiment of present application uses the corresponding instructions in the above instruction set to “describe” the configuration operations on the registers. Each group of instructions that describes “the minimum execution granularity” constitutes one execution unit.

Step 103, detecting the execution units, and when detecting that there are multiple execution units corresponding to the same type of operation request and multiple execution units include multiple instructions of the same type corresponding to the same register address, merging and optimizing the multiple execution units to generate optimized execution units, and sending the optimized execution units to the bus.

In the scenario where there is only one execution unit, due to the execution unit corresponds to the “minimum execution granularity”, each instruction in the execution unit points to a different register address, and it is impossible to merge the instructions in the execution unit to execute. Therefore, for the scenario of a single execution unit, the instructions in the execution unit can be directly sent to the bus in the execution order, and then transmitted by the bus to the corresponding low-speed device. In scenarios where there are multiple execution units (such as batch operations of certain functions), there may be multiple instructions of the same type pointing to the same register address. If these multiple instructions of the same type can be merged to execute, the number of the accesses to the register can be reduced, thereby improving system performance. For example, when three groups of functions of the low-speed device of FIG. 1 are enabled at the same time, three groups of operations can be generated as shown in FIG. 4, and the three groups of operations are executed sequentially from top to bottom, and the three groups of operations can be converted into three execution units as shown in FIG. 4 by using the instructions in the instruction set, that is, a first execution unit, a second execution unit, and a third execution unit as shown in FIG. 4, which are executed sequentially from top to bottom and the instructions in each execution unit are also executed sequentially in order of their serial number. For example, each execution unit includes three instructions: I, II, and III, the three instructions I, II, and III in each execution unit are executed sequentially in the order of the first execution unit, the second execution unit, and the third execution unit, resulting in a total of 9 instructions to be executed.

It can be seen that the I instructions in the three execution units mentioned above, namely “REG-AND E-addr, 0x1E”, “REG-AND E-addr, 0x1D”, and “REG-AND E-addr, 0x1B”, all have operation fields of “REG-AND” and address fields of “0xE”, and the data fields of the I instructions correspond to different storage units of the register E. These three instructions belong to multiple instructions of the same type pointing to the same register address. Similarly, the III instructions in the three execution units mentioned above, namely “REG-OR E-addr, 0x1”, “REG-OR E-addr, 0x2”, and “REG-OR E-addr, 0x4”, also belong to the multiple instructions of the same type pointing to the same register address.

When there are multiple execution units and there are multiple instructions of the same type pointing to the same register address in multiple execution units, after determining these instructions comply with optimization rules, these instructions of the same type are merged and optimized to form a merged and optimized instruction (also referred to as “merged instruction” or “optimized instruction” in the article). Determining whether the instructions comply with optimization rules includes determining whether the merging of these instructions will affect the final execution effect. Taking the above three execution units as an example, assuming if multiple instructions of the same type pointing to the same register address in the above three execution units can be merged and optimized, the merged execution units are shown in FIG. 5. After merging, the 9 instructions are merged into 5 instructions, and the positions of the instructions that are merged into the merged instruction can be filled with NOP. NOP is a null operation and does not perform any operation. In the embodiments of the present application, NOP may not be counted in the number of instructions.

Wherein, the I instructions in the three execution units, namely “REG-AND E-addr, 0x1E”, “REG-AND E-addr, 0x1D”, and “REG-AND E-addr, 0x1B”, are merged into the instruction “REG-AND E-addr, 0x18”. For the AND instruction REG-AND, an AND operation is performed on data values 0x1E, 0x1D, and 0x1B in the data fields of the three instructions before merging to obtain a data value 0x18 in the data field of the merged instruction. It can be understood that the operation field and the address field of the merged instruction are the same as those of the three instructions before merging. The data field of the merged instruction is calculated based on the data fields of the three instructions before merging (that is. 0x1E, 0x1D, 0x1B), ensuring that the operation result of data field of the merged instruction are equivalent to the operation result of data fields of three instructions before merging. Similarly, the III instructions of the three execution units, namely “REG-OR E-addr, 0x1”, “REG-OR E-addr, 0x2”, and “REG-OR E-addr, 0x4”, are merged into the instruction “REG-OR E-addr, 0x7”. For the OR instruction REG-OR, an OR operation is performed on the data values 0x1, 0x2, and 0x4 in the data fields of the three instructions before merging to obtain a data value 0x7 in the data field of the merged instruction.

After merging and optimizing, the execution order of each instruction has changed. For example, the I instruction (REG-AND E-addr, 0x1D) in the second execution unit before merging is the 4th in the execution order, but after merging, it is the 1st in the execution order. Similarly, the III instruction in the first execution unit before merging is the 3rd in the execution order, but after merging, it is the last in the execution order.

It is not difficult to find that a relative order of the instructions in each execution unit remains unchanged before and after merging. For example, as shown in FIG. 5, the three instructions in the second execution unit are the 4th, 5th, and 6th in the execution order before merging. After merging, although the three instructions in the second execution unit become the 1st, 3rd, and 5th in the execution order, the relative order remains unchanged.

Whether this sequent characteristic will affect the final execution effect is determined by the optimization rules. Specifically, the embodiment of the present application predefines a group of optimization rules based on the characteristics of each chip/device, in which each register address is marked, and if a certain register address is marked as an optimizable address, it indicates that merging and optimizing the multiple instructions of the same type pointing to the register address will not affect the final execution effect. For example, as long as the relative order in which the instructions of each execution unit are executed remains unchanged after merging, the desired execution effect can still be obtained. Therefore, after detecting an existence of multiple instructions of the same type pointing to the same register address, the present embodiment can check the optimization rules, so as to determine whether the register address corresponding to the multiple instructions of the same type is marked as optimizable. When determining that the register address is an optimizable address, mergence and optimization can be performed.

In some embodiments, the same type of instructions mentioned above may include bit operation instructions, such as OR instructions, AND instructions, and shift instructions, etc. That is to say, the present embodiment may choose to merge and optimize multiple bit operation instructions of the same type pointing to the same register address. The following will provide a specific explanation of the merging and optimizing process of the OR instruction and the AND instruction in conjunction with FIGS. 4 and 5. The merging and optimizing process of other instructions is similar, and will not be repeated here.

As shown in FIGS. 4 and 5, before merging, the I instructions in the three execution units belong to instructions of the same type (all have the operation fields of REG-AND) pointing to the same register address (address of the register E). The III instructions in the three execution units belong to instructions of the same type (all have the operation fields of REG-OR) pointing to the same register address (address of the register E). If the register address (address of the register E) has been marked as optimizable under the optimization rule, the I instructions in the three execution units can be merged and optimized, and the IIII instructions in the three execution units can also be merged and optimized at the same time, that is to say, the I and III instructions in the three execution units are all instructions to be merged.

Before merging, preceding instructions (instructions executed before the instructions to be merged) and succeeding instructions (instructions executed after the instructions to be merged) to be merged for each execution unit are recorded. For example, in the first execution unit, I instruction has no preceding instruction, and its succeeding instructions are the II instruction and the III instruction; the preceding instructions of the III instruction are the I instruction and the II instruction, and the III instruction has no succeeding instruction. Similarly, in the second execution unit, I instruction has no preceding instruction, and its succeeding instructions are the II instruction and the III instruction; the preceding instructions of the III instruction are the I instruction and the II instruction, and the III instruction has no succeeding instruction. In the third execution unit, the I instruction has no preceding instruction for the I instruction, and its succeeding instructions are the II instruction and the III instruction; the preceding instructions of the III instruction are the I instruction and the II instruction, and the III instruction has no succeeding instruction.

Afterwards, the instructions to be merged are merged to generate a merged OR instruction. Wherein, an operation field and an address field of the merged OR instruction are the same as those of the OR instructions before merging, while the data field of the merged OR instruction is generated based on all the data fields of the OR instructions before merging. Taking the III instructions in the three execution units mentioned above as an example, the III instructions in the three execution units are the three OR instructions to be merged. Firstly, masks of these three OR instructions are obtained, and OR operation is performed on all the masks obtained to generate a merged mask. The merged mask is the data field of the merged OR instruction. From this, it can be seen that the merged instruction of these three instructions is “REG-OR E-addr, 0x7”. The process of merging AND instructions is similar and will not be repeated here. The merged instruction of the I instructions (i.e. the three AND instructions to be merged) of the three execution units mentioned above is “REG-AND E-addr, 0x18”.

Then, based on the order of each execution unit and the relative order between instructions in each execution unit, all preceding instructions may be moved ahead the merged instruction, and all succeeding instructions may be moved behind the merged instruction, forming the merged execution units. For example, for each I instruction in the three execution units mentioned above, it has no preceding instruction, so an instruction formed after merging the I instructions in the three execution units is the first in the execution order. For each III instructions in the three execution units mentioned above, it has no succeeding instruction, therefore, an instruction formed after merging the III instructions in the three execution units mentioned above is the last in the execution order, and the remaining three instructions (i.e. the II instructions in the three execution units) belong to the succeeding instructions of the I instructions in the three execution units mentioned above, and belong to the preceding instructions of the III instructions in the three execution units mentioned above. Therefore, the remaining three instructions are between the first and the last in the execution order, and considering the order of each execution unit, the merged execution unit in FIG. 5 may be obtained.

Specifically, after merging and optimizing multiple instructions of the same type pointing to the same register address, it is also necessary to sort the instructions that do not participate in merging and optimizing and merged instructions formed after the merging and optimizing based on the order of the respective execution units and the relative order of the instructions among the instructions in each execution unit, so as to ensure that the relative order among instructions remains unchanged.

In the implementation method of this application, an instruction set is created for accessing the device. When operating on the device, corresponding instructions are selected from the instruction set and execution units with the minimum execution granularity corresponding to the operation requests are generated. When multiple execution units corresponding to the same type of operation request and including multiple instructions of the same type corresponding to the same register address are detected, the multiple execution units are merged and optimized to generate optimized execution units and sent to the bus. This can reduce the number of accesses to the low-speed devices and improve system performance.

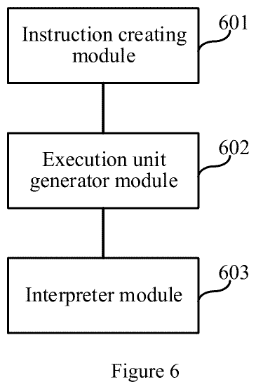

The implementation method of this application also relates to an access system for registers in a device, the device is connected to a CPU via a bus. The device includes multiple registers each corresponding to a different address. Each register includes one or more storage units, and the one or more storage units share a register address. The block diagram of the access system is shown in FIG. 6, and the access system includes: an instruction creating module 601, an execution unit generator module 602, and an interpreter module 603. The instruction creating module 601 is configured to create an instruction set for accessing the device. The execution unit generator module 602 is configured to select corresponding instructions from the instruction set in response to operation requests from the CPU to the device, so as to generate execution units with the minimum execution granularity corresponding to the operation requests. The interpreter module 603 is configured to detect execution units, and when multiple execution units corresponding to the same type of operation request and including multiple instructions of the same type corresponding to the same register address are detected, the interpreter module 603 is used to merge and optimize the multiple execution units to generate optimized execution units, and send the optimized execution units to the bus.

The present embodiment is a system embodiment corresponding to the method embodiment described above, and the technical details in the method embodiment described above can be applied to the present embodiment, and the technical details in the present embodiment can be applied to the method embodiment described above.

In summary, compared to traditional bus access where access requests (configuration operations) to registers are directly sent to the bus, in scenarios of batch operations, frequent accesses to certain registers including multiple register units may be required, thus reducing the performance of the system. The present application firstly converts access requests to registers into instructions using a predefined instruction set, then merges and optimizes some of the instructions according to the characteristics of the instructions, and then sends the optimized instructions to the bus, which greatly reduces the number of accesses to the corresponding registers and improves the system performance.

It should be noted that those skilled in the art should understand that the implementation functions of the various modules shown in the embodiments of the above access system for the registers in the device can be referred to the relevant description of the foregoing access method for the registers in the device. The functions of each module shown in the implementation of the access system for the registers in the device mentioned above can be achieved through programs (executable instructions) running on the processor, or through specific logic circuits. If the access system for the registers in the device mentioned in the present embodiment is implemented in the form of a software functional module and sold or used as an independent product, it can also be stored in a computer-readable storage medium. Based on this understanding, the technical solutions of the embodiments of the present invention can be embodied in the form of software products in essence or part of contributions to the prior art. The computer software product is stored in a storage medium, and includes several instructions to enable a computer device (which may be a personal computer, server, or network device, etc.) to perform all or part of the methods described in the embodiments of the present invention. The foregoing storage media include various media that can store program codes, such as a U disk, a mobile hard disk, a read-only memory (ROM, Read Only Memory), a magnetic disk, or an optical disk. In this way, the embodiments of the present invention are not limited to any specific combination of hardware and software.

Correspondingly, the embodiments of the present invention also provide a computer-readable storage medium in which computer-executable instructions are stored. When the computer-executable instructions are executed by a processor, the method embodiments of the present invention are implemented. The computer-readable storage media comprises permanent and non-permanent, removable and non-removable media can be used by any method or technology to implement information storage. Information can be computer-readable instructions, data structures, program modules, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only optical disc read-only memory (CD-ROM), digital multifunctional optical disc (DVD) or other optical storage, magnetic cartridge tapes, magnetic tape disk storage or other magnetic storage devices, or any other non-transport media that can be used to store information that can be accessed by computing devices. As defined herein, a computer-readable storage medium does not include transient computer-readable media (transitory media), such as modulated data signals and carriers.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises multiple elements includes not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

All documents mentioned in this specification are considered to be included in the disclosure of this application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

In some cases, the actions or steps described in the claims can be performed in a different order than in the embodiments and still achieve desired results. In addition, the processes depicted in the drawings do not necessarily require the specific order or sequential order shown in order to achieve the desired results. In some embodiments, multitasking and parallel processing are also possible or may be advantageous.

What is claimed is:

1. A method for accessing registers of a device, wherein the device is connected to a CPU via a bus, the device comprises multiple registers, each of which corresponds to a different address, and each register comprises one or more storage units which share a register address, and the method comprises:
creating an instruction set for accessing the device;
in response to operation requests from the CPU to the device, selecting corresponding instructions from the instruction set, so as to generate execution units with a minimum execution granularity corresponding to the operation requests;
detecting the execution units, and when detecting that there are multiple execution units corresponding to the same type of operation request and the multiple execution units comprises multiple instructions of the same type corresponding to the same register address, merging and optimizing these multiple execution units to generate optimized execution units, and sending the optimized execution units to the bus.

2. The method according to claim 1, wherein the method further comprises: detecting whether the register address corresponding to these multiple instructions of the same type is marked as an optimizable address, and merging and optimizing these multiple execution units when determining that the register address is the optimizable address.

3. The method according to claim 1, wherein merging and optimizing these multiple execution units comprises: merging these multiple instructions of the same type corresponding to the same register address of the multiple execution units and generating an optimized instruction.

4. The method according to claim 3, wherein merging and optimizing these multiple execution units comprises: sorting instructions that do not participate in merging and optimizing and the optimized instruction, so that relative order between any two instructions in the optimized execution units is the same as their relative order in the execution units before optimization.

5. The method according to claim 3, wherein each of the instructions in the instruction set comprises an operation field, an address field, and a data field.

6. The method according to claim 5, wherein operation fields and address fields of these multiple instructions of the same type are the same, and data fields of these multiple instructions of the same type correspond to different storage units of the register.

7. The method according to claim 5, wherein merging multiple instructions of the same type corresponding to the same register address comprises: performing calculation on data in the data fields of these multiple instructions of the same type corresponding to the same register address based on the operation fields of these multiple instructions of the same type to obtain data in the data field of the optimized instruction, the operation field and the address field of the optimized instruction are respectively the same as those in the operation fields and the address fields of these multiple instructions of the same type.

8. The method according to claim 7, wherein these multiple instructions of the same type are bit operation instructions of the same type.

9. The method according to claim 1, wherein the instruction set is created in a domain specific language manner.

10. A system for accessing registers of a device, wherein the device is connected to a CPU via a bus, the device comprises multiple registers, each of which corresponds to a different address, and each register comprises one or more storage units which share a register address, and the access system comprises:
an instruction creating module, configured to create an instruction set for accessing the device;
an execution unit generator module, configured to select corresponding instructions from the instruction set in response to operation requests from the CPU to the device, so as to generate execution units with the minimum execution granularity corresponding to the operation requests;
an interpreter module, configured to detect the execution units, and when multiple execution units corresponding to the same type of operation request and comprising multiple instructions of the same type corresponding to the same register address are detected, merge and optimize the multiple execution units to generate optimized execution units, and send the optimized execution units to the bus.
